(19) United States
(12) Patent Application Publication
(10) Pub. No.: US 2011/0055303 A1
(43) Pub. Date: Mar. 3, 2011

(54) Function Generator

(75) Inventor: Keith Slavin, Beaverton, OR (US)

(73) Assignee: AZURAY TECHNOLOGIES, INC., Tualatin, OR (US)

(21) Appl. No.: 12/724,384

(22) Filed: Mar. 15, 2010

Related U.S. Application Data
(60) Provisional application No. 61/239,756, filed on Sep. 3, 2009.

(51) Int. Cl. G06F 1/03; G06F 7/44; G06F 7/42

(52) U.S. Cl. 708/276; 708/523

(57) ABSTRACT

One embodiment relates to a method for generating a periodic function in response to an argument in a digital signal processing system, where the periodic function can be represented as functions of two or more components of the argument. The method may include: obtaining a first operand from one of two or more lookup tables in response to a first component of the argument; obtaining a second operand from one of the lookup tables in response to a second component of the argument; conditionally mirroring the first and second operands in response to a quadrant of the argument; and calculating a value of the periodic function in response to the operands with a linear algebra unit without using conditional code execution.

### CROSS-REFERENCE TO RELATED APPLICATIONS

This application claims priority from U.S. Provisional Patent application Ser. No. 61/239,756 filed Sep. 3, 2009, which is incorporated by reference.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

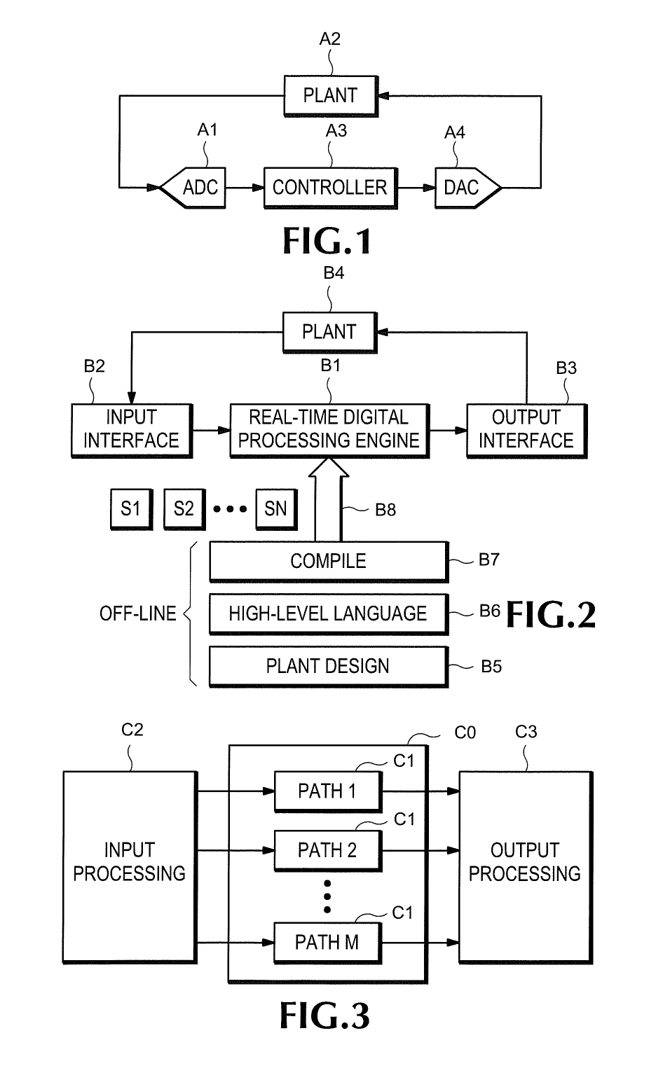

FIG. 1 illustrates the structure of a typical analog plant with digital control using feedback. An analog-to-digital converter (A/D converter or ADC) A1 converts one or more analog signals from a plant A2 to a digital form usable by a digital controller A3. The controller outputs digital control signals that are converted back to the analog domain by a digital-to-analog converter (DAC) A4 which is connected to the analog plant control inputs. Conversion usually occurs at a constant rate, expressed in samples-per-second. The digital controller uses this information to compare the digitized signals with an ideal behavior, and send one or more correction control signals back to the plant in order to make the plant behave in the desired manner.

In a typical system shown in FIG. 2, the system of FIG. 1 uses a real-time digital processing engine B1 to act as the digital controller. The real-time requirement arises from the need to process all inputs from the ADCs and write new outputs to one or more DAC or Pulse-Width-Modulator (PWM) units before the next set of input samples arrives. In many systems, the period to complete the digital processing corresponds to a fixed delay, and must be small enough that the control loop can keep the plant operation stable. If the delay were to be extended, achieving stability in the plant may not be possible, and undesirable oscillations may occur in the plant. The digital processing B1 is commonly some sort of processor, usually a Digital Signal Processor (DSP), which runs software compiled for it. Usually, the plant design process B5 mandates an ideal control behavior which is expressed in a high level language (e.g. the C language) B6, and then a compiler B7 generates instruction data which is loaded through a communications channel B8 into the target DSP B1. States S1, S2, . . . SN represent system configurations that may be loaded into the system.

In a typical processor-based digital control loop for a plant, many inputs need to be processed, and possibly several outputs need to be generated. FIG. 3 illustrates several control paths from inputs to outputs within a DSP. Each path C1 is typically implemented using some sort of prioritized and scheduled processor interrupts. Each interrupt runs the code for a path at a regular period. At the start of each interrupt, input processing reads various inputs, processes the data, and writes new outputs to control the plant. If all interrupts are guaranteed to finish within the maximum delays that ensure stable plant operation, then although the processor can only execute the code for one path at a time, the system will still operate properly. An alternative would be to have M smaller processors, one for each of paths 1-M, but this is usually more expensive.

In many control systems, designers simplify the design by sampling all analog input data from the plant at about the same time, and all with the same period between sampling a given input. The regular sampling ensures simpler and faster processing of the input data. Similarly, after all paths are processed and written to output storage, new output values are written to DACs or PWMs. The output storage is typically double buffered for each DAC or PWM, that is, a two-deep buffer is written at one location while the DACS and PWMs read from the other. When all new output value updates are completed, the DACs and PWMs are switched to read from the new values, and the previous set of DAC and PWM values then become available to be overwritten by the next new set of values, etc. Double buffering therefore can hide the order of processing each path within FIG. 3, and the processing of paths can occur in any order, as long as all are finished before the start of the next period. This allows a single processor to process many paths as if it were multiple small processors, one dedicated to each path.

Many applications require only linear processing operations, such as linear convolution (FIR filtering), multiplication (scaling), addition (offsets), and sometimes sine and cosine functions of sample time for the purposes of modulation and demodulation. Accordingly, there is a need for a special purpose and energy efficient programmable processor architecture that can nevertheless achieve high data throughput compared to a conventional DSP.

### DETAILED DESCRIPTION

Some of the inventive principles of this patent disclosure relate to a special-purpose digital processor and controller, with the objective of trying to keep its central multiplier-accumulator (MAC) as fully utilized as possible. The controller may be externally programmed to execute a set of instructions within an A/D input sample period. All MAC data I/O may be stored in a dedicated and tightly coupled data memory, which may also take external data inputs, such as from the A/D converters. Multiple threads with very fast context-switching are supported in hardware in order to hide the pipeline delays inherent in MAC implementations, and thereby avoid write-before-read data hazards. The controller may have a stack memory for function calls, but in some embodiments, only for the purpose of pushing return addresses onto the stack. The processor may also support sine and cosine functions of sample time.

### Configurable Controller

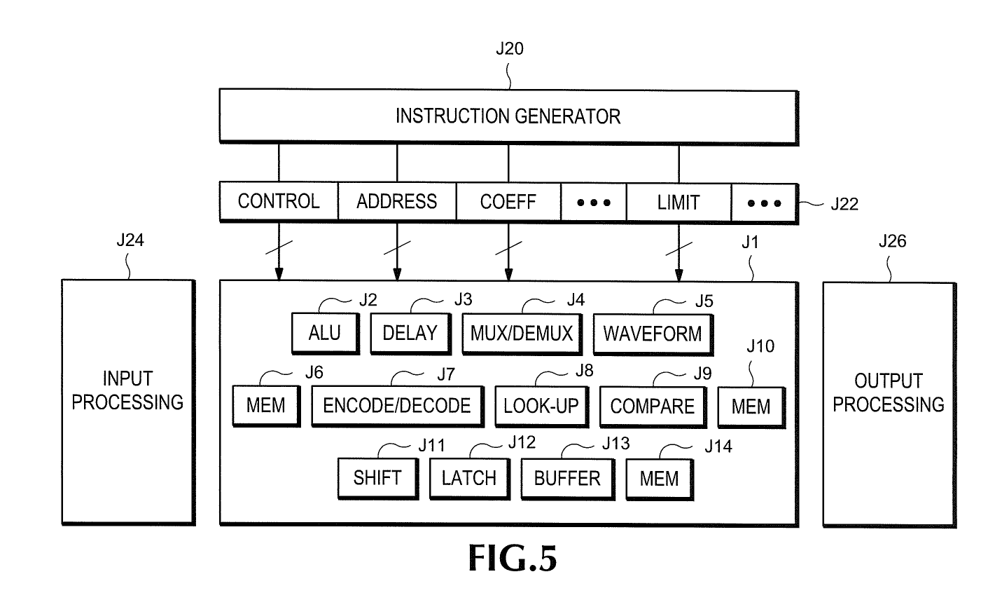

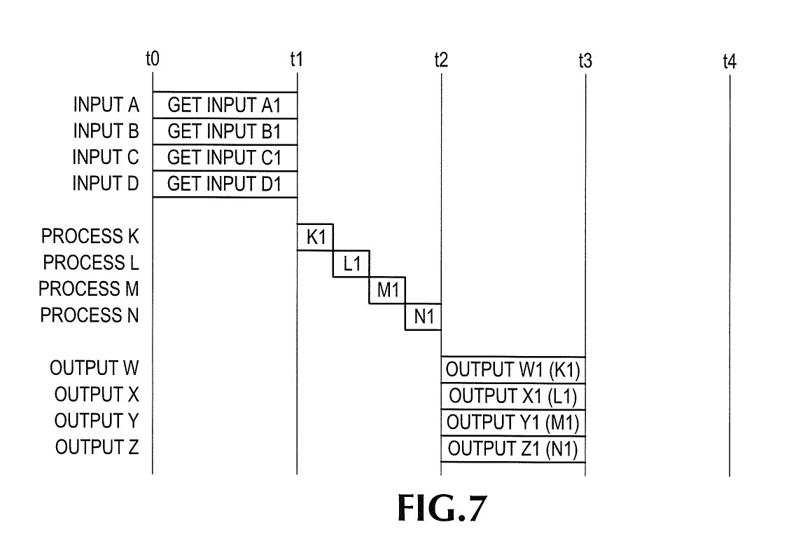

FIG. 7 illustrates an embodiment of a processing engine according to some of the inventive principles of this patent disclosure. The embodiment of FIG. 5 includes an operation unit J1 having various hardware resources J2-J14. An instruction generator J20 generates instructions J22 which control the operation unit J1. The embodiment of FIG. 5 may also include an input processing unit J24 and/or an output processing unit J26. If present, the input and/or output processing units may be separate from, or integral with, the operation unit J1.

The hardware resources J2-J14 may include any type of hardware that may be useful for processing digital signals. Some examples include arithmetic units, delays, memories, multiplexers/demultiplexers, waveform generators, decoders/encoders, look-up tables, comparators, shift registers, latches, buffers, etc. The operation unit may include multiple instances of any of the hardware resources, which may be arranged individually, in functional groups, or in any other suitable arrangement.

Although the inventive principles are not limited to any specific arrangement, in some embodiments it may be particularly beneficial to include multiple memories J6, J10, J14 throughout the operation unit as shown in FIG. 5 to facilitate multi-threading, context switching, limit checking, etc. Multiple memories may also enable improved cycle utilization of other resources such as arithmetic units, comparators, etc.

The instruction generator J20 may be implemented in hardware, software, firmware or a hybrid combination. The instruction words J22 provided by the instruction generator may include any number of fields that define the actions of the operation unit J1. Examples of fields that may be included in the instruction words include control information, address information, coefficients, limits, etc.

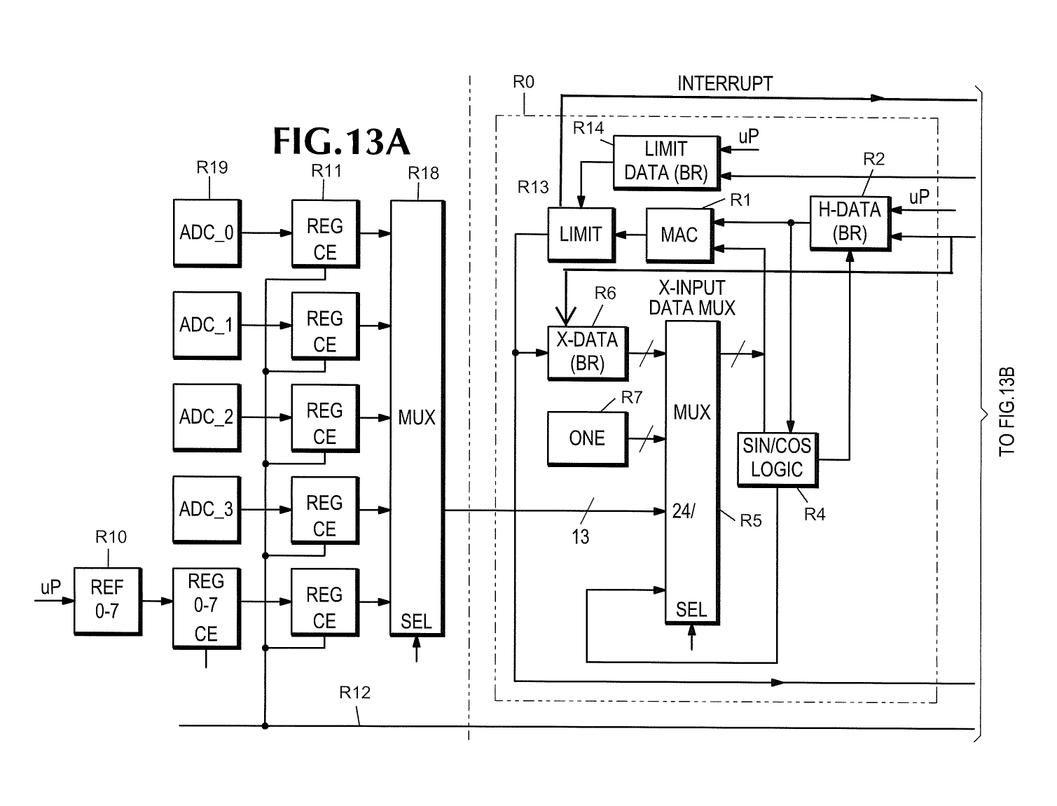

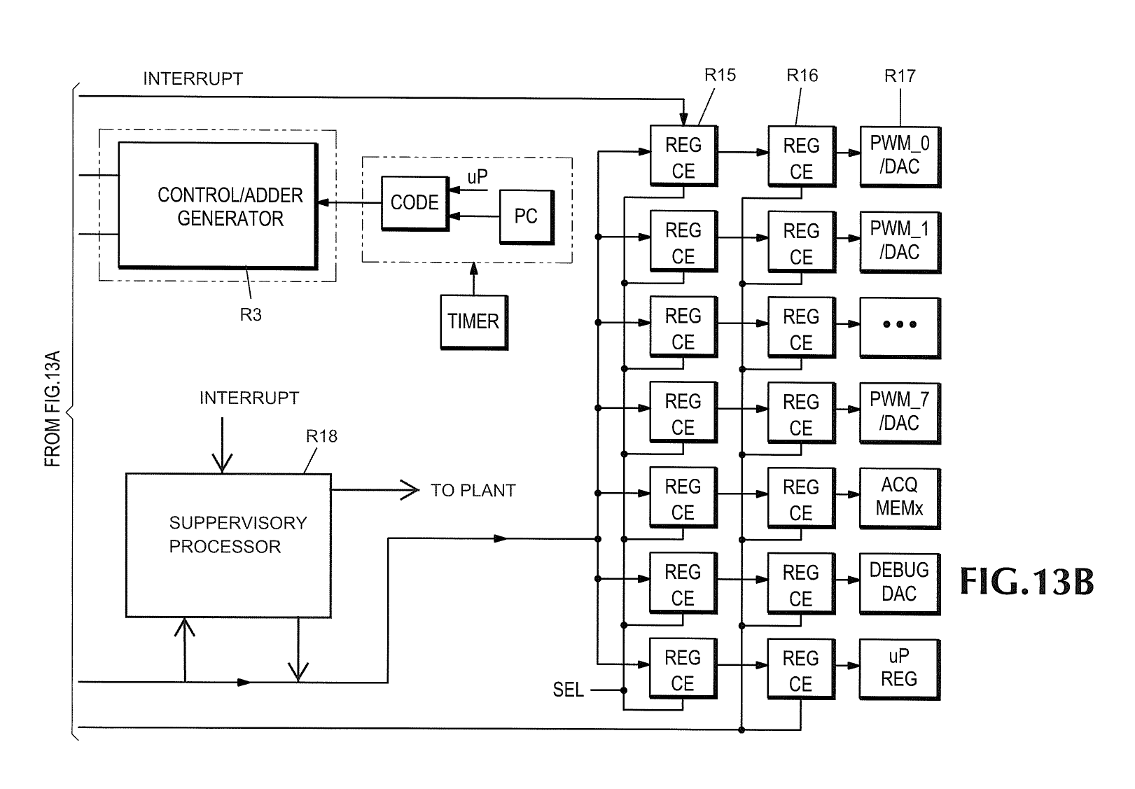

FIG. 13 illustrates an embodiment of a digital processing system according to some of the inventive principles of this patent disclosure. For purposes of illustration, the embodiment of FIG. 13 also illustrates several implementation details such as specific types, numbers and arrangements of hardware resources, etc., but the inventive principles are not limited to these details.

The embodiment of FIG. 13 includes a processing unit R0 having a multiply-accumulate (MAC) unit R1 that provides the core arithmetical functionality of the system. In this embodiment, the remaining hardware resources are arranged in a configuration that enables a high level of MAC utilization. One input to the MAC is provided by a first multiplexer R5 that closes a feedback loop around the MAC. One input to the first multiplexer is provided by an X-data Random-Access-Memory (RAM) memory R6 that stores outputs from the MAC. Additional inputs to the first multiplexer are provided by a coefficient circuit R7, sine/cosine generator logic R4, and a second multiplexer R8. The coefficient circuit R7 may provide, for example, a constant value such as one (1) which may be used by the MAC as a multiplier to enable data to pass through the MAC essentially unchanged. The second input to the MAC is provided by an H-data RAM R2 that, prior to execution, is normally pre-programmed by an external microprocessor that is not shown in this Figure. During execution, the H-data RAM is read-only, with a read address multiplexed by a second multiplexer inside the H-data RAM from an instruction generator R3, or from sine/cosine logic R4. The sine/cosine logic R4 may be useful, for example, for generating sinusoidal waveforms for phase locking and modulation/demodulation applications.

The third multiplexer R8 selects one of multiple sampled inputs from A/D converters R9, reference values R10 which may be provided, for example, by an external or supervisory microprocessor, or from any other suitable input interface resources. The inputs to the second multiplexer R8 may be latched in input registers R11 to synchronize data transfers with tick events on timing signal R12.

A limit checking circuit R13 may be included to provide hardware limit checking on the MAC outputs based on limit data stored in Limit-data RAM memory R14. As with the H-data RAM memory, the Limit-data memory is pre-programmed by the external microprocessor prior to operation. During normal operation, the RAM is read-only, reading data at the same address as the write address to the X-data RAM R6, and essentially limiting the range of values that are allowed to be written at each X-data RAM memory location. The Limit-data RAM is split into two sets of data, upper limits, and lower limits, and each can be set separately by the external processor. A special lower and upper limit code combination (such as a lower limit being greater than an upper limit) can represent a “no limit” state, leaving the MAC output value unchanged if required.

Outputs are taken from the MAC output, with or without limiting, and also applied to the inputs of a first set of registers R15. A second set of registers R16 may be included to synchronize the outputs with tick events on timing signal R12.

In typical operation, a set of data may be read from the input registers R11 on one tick event, processed during the interval between tick events and written to output register R15 as each becomes ready. The corresponding output data from R15 is then written into the output registers R16 on the next tick event, which simultaneously starts the processing of the next set of input data from R11, thereby forming a processing pipeline.

Typically, systems are designed to execute tens to hundreds of MAC instructions between each tick event. If tick periods are too long so that very large numbers of MAC instructions can be executed per tick period, then the system's minimum delay is increased, and its effectiveness in control loops becomes increasingly limited.

If too few MAC instructions can be executed per tick period, then some operations such as linear convolution could not be completed within a single tick period. Furthermore, more complex processing may require splitting a path into multiple paths. In this case, the paths may communicate the results of one path to the next path via X-data memory. The overhead of these extra X-data RAM accesses may become unacceptable.

The outputs from the output latches R16 may be applied to D/A converters, PWMs, or any other suitable output interface resources R17.

The processing unit R0 is controlled by a stream of MAC instruction words from the instruction generator R3. One type of information in an instruction word is an operand address to the H-data memory R2. Another is an operand address to the Limit-data RAM and X-data RAM. For example, if the processing unit is to implement a finite impulse response (FIR) filter, the filter coefficients may be read from the H-data memory through the instruction words, multiplied by the X-data from R6 at another address (via multiplexer R5), accumulated in the MAC, and the result written to another address in the X-data RAM (via limiter R13).

Control information may also be included in an instruction word. For example, the control information may instruct the first and second multiplexers R5 and R8 which inputs to use for an operation, it may instruct the MAC to begin a multiply-accumulate operation, it may instruct the processing unit where to direct the output from a MAC operation, etc.

A feature of the processing unit R0 is that it does not rely on conditional branch logic which is used in conventional systems for checking and decrementing loop counters, checking limits of arithmetic results, etc. Conditional branch logic typically reduces cycle efficiency in conventional systems because the MAC or other arithmetic logic unit (ALU) remains idle while branch instructions are executed in order to test the result of execution.

Instead of using branch logic, the processing unit R0 is fed a continuous stream of MAC instruction words from the generator R3 which handles any loop counting. For example, to implement a 5-tap FIR filter, the processing unit may be fed a continuous stream of five MAC instruction words. Each instruction specifies the source and destination of the data used for the MAC operation. After the fifth instruction is executed, the processing unit may proceed to the next set of instructions provided by the instruction generator. Thus, rather than spending time keeping track of loop iterations, the processing unit may continuously perform substantive signal processing at a high level of cycle utilization.

The use of hardware limit checking may also improve cycle utilization. Rather than executing “compare and branch” instructions to check the limits of mathematical results, the outputs from the MAC may be checked in hardware on a cycle-by-cycle basis or at any other times using Limit-data that is provided in instruction words and stored in Limit-data memory R14. This may enable low or no overhead limit checking.

The hardware limit checking may enable the processing unit to immediately shut down the outputs and/or transfer control to a supervisory processor R18 upon detection of a parameter that is out of bounds.

The hardware limit checking may also enable the supervisory processor to monitor the system operation on a tick-by-tick or even a cycle-by-cycle basis to provide fast response to parameters that are out of bounds or other fault conditions. For example, the supervisory processor may disable the outputs, shut down a plant that is controlled by the processing unit, issue an alarm, send warning message, or take any other suitable action.

Another feature of the processing unit R0 is the use of distributed memories. The X-data, H-data and Limit-data memories may enable simultaneous access by different hardware resources, thereby reducing cycle times. They may also be located physically close to the resources that utilize them, thereby reducing signal propagation delays. Moreover, the use of distributed memories may enable efficient context switching for multi-threading and other types of interleaved processes.

The embodiment of FIG. 13 may be used to implement any of the previous embodiments of digital control systems, but is not limited to such applications. For example, each path and/or section shown in the embodiment of FIG. 3 may be implemented as a separate thread or process in the embodiment of FIG. 13.

### Timing Methods

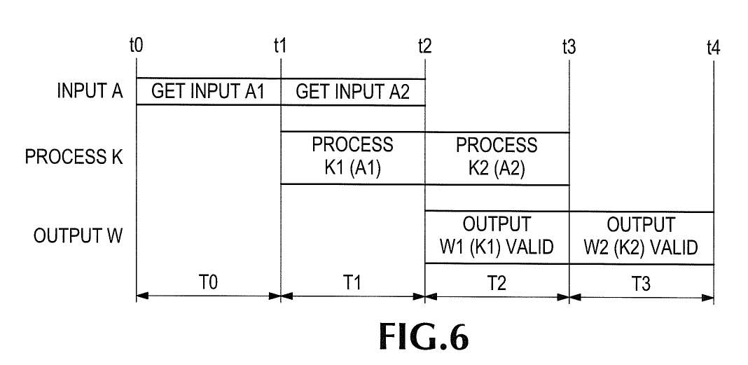

FIGS. 6-12 illustrate embodiments of methods for processing digital signals according to some of the inventive principles of this patent disclosure. The embodiments of FIGS. 6-11 may be implemented, for example, with any of the systems described above with respect to FIGS. 2-5, or with embodiments described below.

The embodiments of FIGS. 6-12 are described in the context of a timing signal which may be described as having cycles punctuated by periodic ticks or tick events at times, t0, t1, . . . tn, which are separated by intervals T0, T1, . . . Tn. However, for economy of language and ease of discussion of these and other embodiments, the time intervals between ticks may also be referred to as ticks, since the meaning is apparent from context. Thus, if an action is described as taking place “during a tick,” “within a tick,” “during tick 1,” or “during tick T1,” it is understood to refer to a time interval between ticks such as the time interval T1 between ticks t1 and t2.

FIG. 6 illustrates a method having a single input A, a single process K, and a single output W. During a time interval T0 between ticks t0 and t1, a first instance A1 of input A is sampled, converted, read or otherwise obtained for use in the process K. At tick t1, the input A1 is made available to process K1, which is an instance of process K, and which is executed during the time interval T1 between ticks t1 and t2. Process K1 is performed using input A1 during interval T1, thus process K1 is shown as a function of input A1 as follows: K1(A1). Also during interval T1, a second input A2 is obtained.

At tick t2, process K1(A1) is completed, and the result is applied to output W as an instance W1(K1) during interval T2. A second instance K2(A2) of process K is performed using input A2 during interval T2, and the result is applied as another instance W2(K2) of the output during interval T3. The method continues with additional instances of process K with each instance using an input obtained at the tick at the beginning of the process and output at the tick at the end of the process. Thus, during each time period between ticks, an input is obtained, a process is performed, and an output is provided in an interleaved manner.

An example of the process K is a scaling process where the input is multiplied by a fixed or variable scaling factor. Another example is an offset process where a fixed or variable offset is added to the input.

FIG. 7 illustrates an embodiment of a method having four inputs A-D, four processes K-N, and four outputs W-Z. Each of the processes uses only one of the inputs and provides only one of the outputs. In this embodiment, the processes operate as parallel threads with a portion of each tick being allocated to each of the processes. For example, during T0, inputs A1, B1, C1 and D1 are obtained, and at tick t1, made available to processes K1, L1, M1 and N1, respectively. Each of the processes K1 L1, M1 and N1 use a portion of T1 to perform its respective function, and at t2, the results of the processes are provided as outputs W1, X1, Y1 and Z1, respectively.

The embodiment of FIG. 7 illustrates an example in which multiple memories may enable multi-thread operation. At tick t1, inputs A1, B1, C1 and D1 may be stored in separate memories so that processes K1, L1, M1 and N1 can access their corresponding inputs during their respective portions of interval T1.

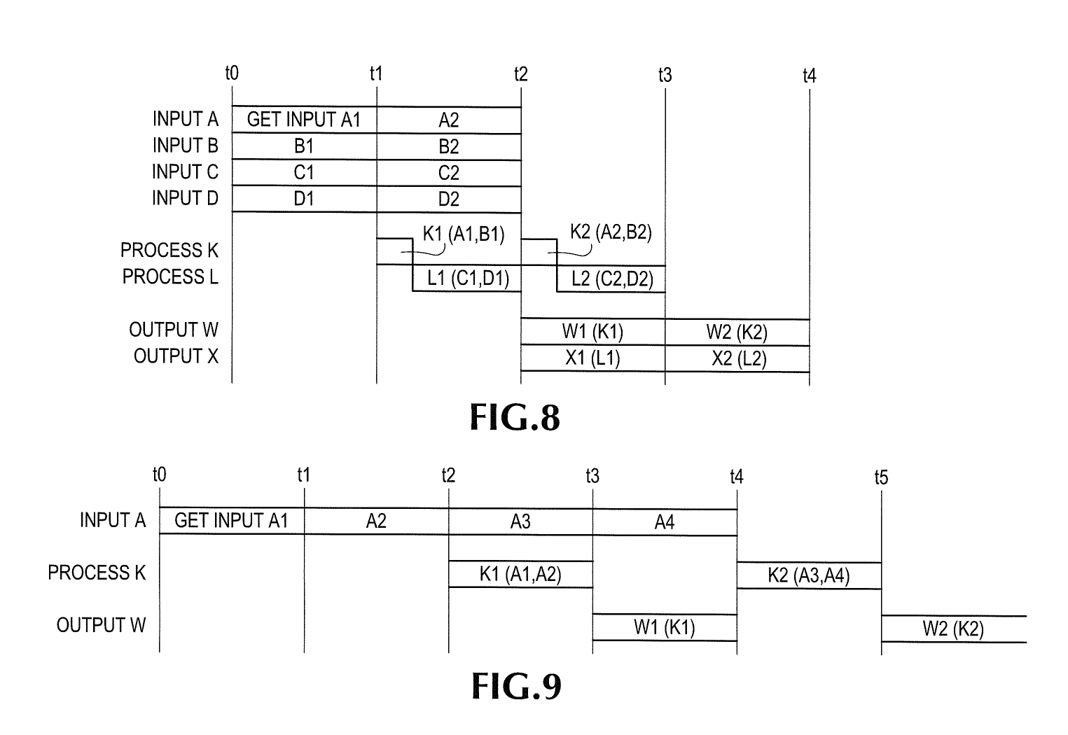

FIG. 8 illustrates an embodiment in which each process uses more than one input, but provides a single output. Specifically, process K uses inputs A and B to provide output W, while process L uses inputs C and D to provide output X. For example, during interval T0, inputs A1, B1, C1 and D1 are obtained, and at tick t1, made available to processes K1 and L1. Process K1 uses inputs A1 and B1 to provide output W1 at tick t2, whereas process L1 uses inputs C1 and D1 to provide output X1 at tick t2. As in the other embodiments, the processes may continue in an interleaved manner.

FIG. 9 illustrates an embodiment in which a process may use more than one sample or instance of an input. During T2, process K1 uses inputs A1 and A2 to generate output W1. The process must then wait until tick t4 before A3 and A4 are available for process K2, which provides output W2. Examples of processes that may use multiple samples from one input include low-pass filtering, decimation, etc.

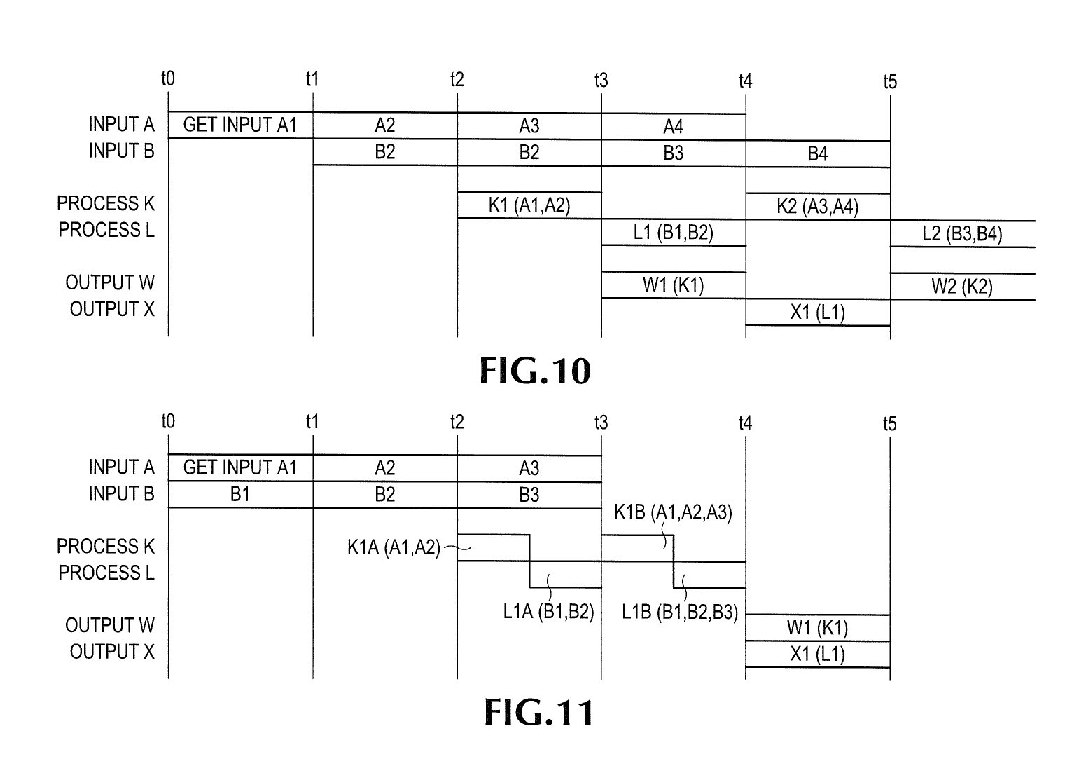

Because process K uses more than one sample from an input for each iteration, it may leave cycles between process iterations during which resources may be available but unused. To achieve better cycle utilization, a second process or thread may be added as shown the embodiment of FIG. 10.

FIG. 10 illustrates an embodiment in which multiple processes may each use more than one sample or instance of an input, and the processes are staggered so that processing is performed between each tick. Process K1 uses inputs A1 and A2 to provide output W1 at tick t3. However, after completing process K1 at tick t3, process K2 cannot begin until samples A3 and A4 are available at tick t4. Process L1, though, can begin at t3 because inputs B1 and B2 are available at tick t3.

FIG. 11 illustrates an embodiment in which an instance of a process may span more than one tick. A first portion of process K1, which is identified as K1A, begins during T2 using inputs A1 and A2. A second portion of K1, identified as K1B, begins during T3 using inputs A1, A2 and A3 and provides output W1. In this example, another process L1 is also split into portions L1A and L1B that span more than one tick to enable the process to use inputs from more than one tick. In such an embodiment, distributed memories may enable more efficient context or thread switching as different portions of processes are suspended, then resumed across multiple ticks.

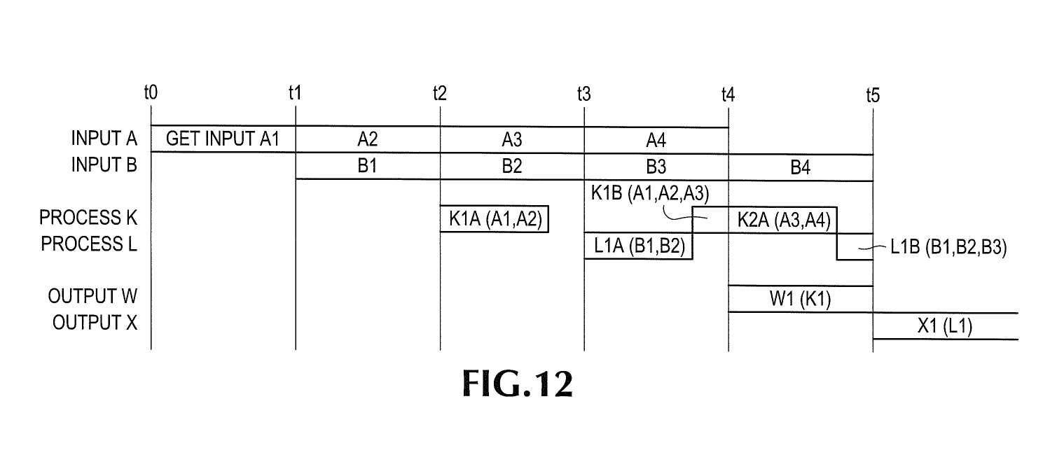

FIG. 12 illustrates another embodiment in which multiple instances span multiple ticks, and use multiple samples from one or more inputs that are staggered across multiple ticks.

### Address Generator

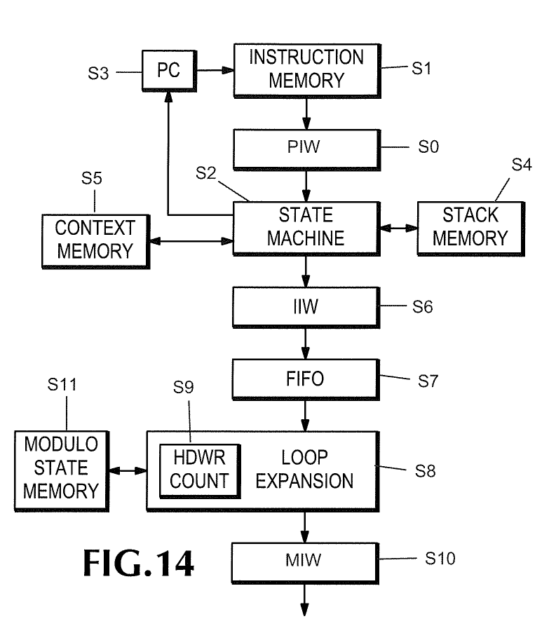

FIG. 14 illustrates an embodiment of an address generator according to some inventive principles of this patent disclosure. The embodiment of FIG. 14 may be used to implement the address generator R3 of FIG. 13, but the inventive principles are not limited to these specific applications.

The instruction generator of FIG. 14 includes a state machine S2 that receives programmed instruction words (PIW) S0 which are relatively high level instructions from an instruction memory S1 under control of a program counter S3. A stack memory S4 allows the state machine to implement subroutine calls. A context memory S5 may be used to store and recall the context of the instruction generator and/or the processing unit S0 to implement multi-threading processes. The state machine outputs a stream of as intermediate instruction words (IIW) S6 that are used internally by the instruction generator.

The intermediate instruction words IIW may include any number of different fields such as control, address, limit, and/or coefficient fields similar to those discussed above with respect to FIG. 13. Another field may include a loop-count that specifies the number of iterations that may be used by a loop expansion unit S8 as described below.

In some embodiments, a first-in, first-out (FIFO) memory S7 may be included to help maintain a steady stream of instruction words out of the instruction generator while accommodating variations in the amount of time it takes the state machine to processes different high level instructions. Some high level instructions such as calls, jumps and context setting instructions may not result in any instruction words being sent to the FIFO, in which case the FIFO occupancy may decrease. However, some instructions implement loop expansions as described below wherein one instruction is expanded into several instructions that are sent sequentially (one-by-one) to the processing unit. During loop expansions, no additional instruction words are read from the FIFO, while instructions may still be issued by the state machine S2, and therefore, the FIFO occupancy may increase.

A loop expansion unit S8 uses the stream of intermediate instruction words IIW to generate a stream of MAC instruction words (MIW) S10 that are applied to the processing unit. The loop expansion unit may include a hardware counter S9 that uses the loop-count field in IIW to determine the number of consecutive MAC instruction words MIW to send to the processing unit. For example, if an intermediate instruction word IIW includes an instruction to perform a FIR filter process, the loop-count field may be set to the number of taps included in the filter. For a 5-tap FIR filter, the loop-count field is set to five. At the beginning of the loop expansion operation, the loop-count field is loaded into the hardware counter S9 which keeps track of the number of MAC instruction words generated by the loop expansion unit. In the case of a 5-tap FIR filter, the hardware counter counts down each iteration until five MAC instruction words MIW have been generated.

The instruction words may be implemented without flow control instructions, thereby eliminating feedback for MAC state information to the address generator. This may simplify the state machine and enable increased operating speeds.

A benefit of the inventive principles is that they may enable the system to set up the MAC unit to execute in response to a single instruction word. This my enable substantial time savings compared to a DSP which typically requires multiple instructions to set up a MAC. For example, in a DSP, it may be necessary to initialize modulo counters and to load various registers or other resources with input, coefficient and/or loop count data, or pointers to such data. All of these operations may take multiple clock cycles to execute before the MAC can begin executing.

In a system that implements some of the inventive principles of this patent disclosure, however, some or all of these setup tasks may be executed through a single instruction word. For example, an intermediate instruction word IIW may include the following fields which, in some embodiments, may be the minimum number of fields needed to set up the MAC unit: a field for the source of input data for the MAC unit; a field for the source of coefficient data for the MAC unit; a field for the destination of output data from the MAC unit; and a field for a loop count. In other embodiments, the minimum fields to set up the MAC unit may also include one or more fields to indicate the type of addressing being used, a field to indicate buffer length, etc. An example embodiment of an intermediate instruction word IIW is illustrated in Appendix A as described below. Depending on the implementation, any subset of the fields shown in Appendix A may be included in an IIW to set up the MAC unit.

The instruction generator and processing unit R0 shown in FIG. 13 may operate at a clock frequency or frequencies that are much higher than the frequency of ticks in the timing signal R12. For example, the processing unit may operate on a clock frequency that is one, two or even three or more orders of magnitude greater than the system clock. Thus, numerous MAC instruction words MIW may be executed by the processing unit between ticks.

The instruction generator of FIG. 14 may also include a modulo state memory S11 which may be used to keep track of modulo buffers for FIR filters, decimation filters and other processes that use modulo structures. This may be helpful, for example, in processes where data is continuously shifted. Rather than actually moving the data, it may be placed in a circular modulo buffer with a wrap-around pointer that marks the logical beginning of the buffer. In such an application, it may be more efficient to store the state of the pointer in the modulo state memory than actually moving the data.

In the embodiment of FIG. 14, the thread granularity is set at the level of the intermediate instruction word IIW. That is, each intermediate instruction word IIW may be directed to a different thread, but within an intermediate instruction word, all operations are directed to a single thread. Thus, an expansion loop for a FIR filter, a decimation filter, or any other multi-loop operation, is dedicated to a single thread and is not broken up between threads.

As an example, if the embodiments of FIGS. 13 and 14 are used to implement the method of FIG. 7, each of the four processes K1, L1, M1 and N1 during tick T1 are controlled by one of four corresponding intermediate instruction words IIW. Within processes K1, L1, M1 and N1, however, multiple MAC instruction words MIW may be executed. For example, if process K1 is a 7-tap FIR filter, and process L1 is a 5-tap FIR filter, the loop expansion unit generates seven MAC instruction words in response to the one intermediate instruction word for process K1. The seven MAC instruction words are then executed by the processing unit to implement process K1. The loop expansion unit then generates five MAC instruction words in response to the one intermediate instruction word for process L1. The five MAC instruction words are then executed by the processing unit to implement process L1. (Implementing FIR filters in processes K1 and L1 may require additional instructions to acquire the requisite input samples, but the example of FIG. 7 is adequate to illustrate the level of granularity for threads within a tick period.)

In other embodiments, the level of granularity may be set at higher or lower levels.

Some additional details and refinements to the system of FIG. 14 are as follows. Referring again to FIG. 7, process K1 and L1 are shown as being executed sequentially with no overlap. In some embodiments, however, there may be overlap in the execution of processes such as K1 and L1, as well as overlap in the execution of instruction words within a process.

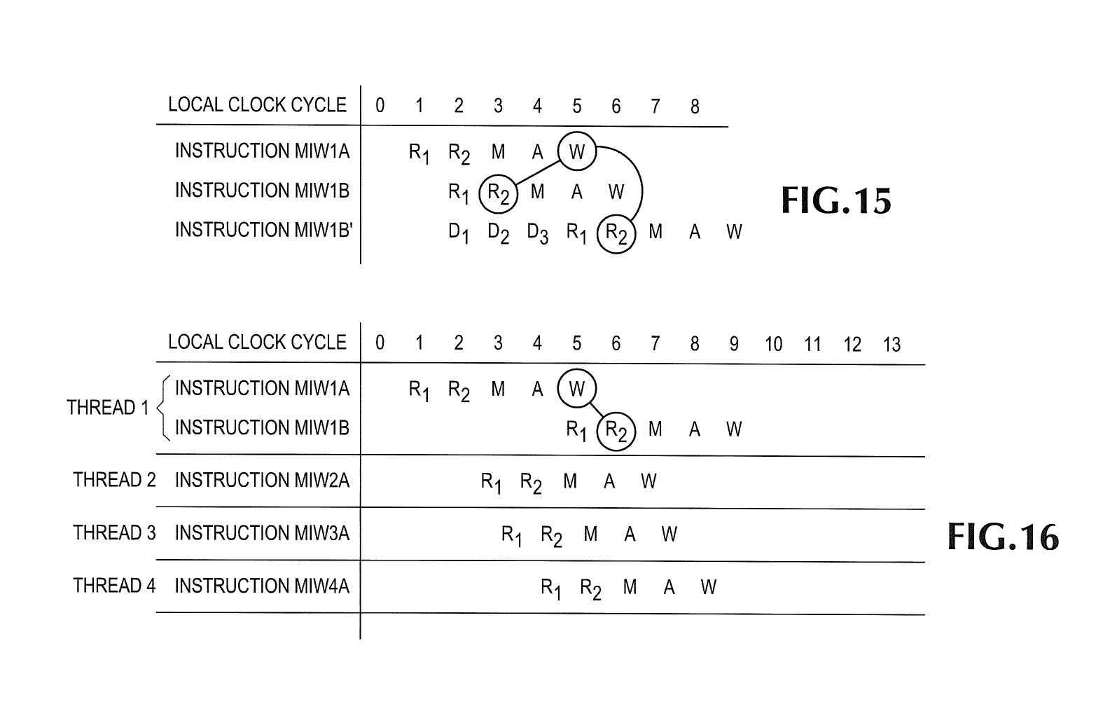

One potential source of inefficiency is the pipeline nature of MAC systems. There may be some pipeline processing delay from beginning a MAC instruction, reading data from the X-data and H-data memories, possibly accumulating the multiplication results, possibly limiting the accumulation result, and writing the limited accumulation result back to X-data memory. This is illustrated in FIG. 15 where a first MAC instruction MIW1A is applied to the processing unit at clock cycle 1. During clock cycles 2-6, the MIW1A instruction reads (R1) from the H-data memory, reads (R2) from a location in the X-data memory, multiplies (M), accumulates (A), and then limits and writes (W) the output back to the same location in the X-data memory.

In general, the instruction generator may attempt to apply a new instruction word MIW to the processing unit during every cycle of the clock to enable the system to operate as fast as possible. However, this may cause a possible write-before-read (WBR) conflict if a subsequent MAC instruction needs to use the result of a prior MAC instruction that is still pending in the pipeline. Referring again to FIG. 15, if the second MAC instruction MIW1B is applied at clock cycle 2, the second read R2 of the second MAC instruction may occur during cycle 3 which is before the first MAC instruction MIW1A writes (W) at cycle 5. Since the second read (R2) of the second MAC instruction uses the same X-data memory location as the write (W) of the first MAC instruction, the data read by the second MAC instruction is invalid.

To avoid this problem, logic may be included in the processing unit to detect the approaching read of a memory location that is shared with, and scheduled to be written to by, a prior instruction. The logic may suspend the next MAC instruction until the write from the prior MAC instruction has been completed as illustrated by instruction MIW1B′ in FIG. 15. Cycle delays or stalls D1, D2 and D3 are added during cycles 2, 3 and 4 to enable the first MAC instruction to write (W) the result at cycle 5 before the second MAC instruction reads (R2) the result at cycle 6. Although this technique correctly resolves the WBR problem, it may sometimes stall the MAC unit, thereby reducing the cycle utilization of the MAC unit.

An approach to resolving the WBR problem without stalling the MAC unit is to use multiple threads in a round robin (circular) manner with each thread using its own resources within the X-data memory. This may enable context switching between threads which, in turn, may reduce or eliminate WBR problems. For example, if the number of threads is at least greater than the number of pipeline cycles between an X-data read used in a MAC instruction, and the final write of the MAC result, there may be no WBR problems at all.

This is illustrated in FIG. 16 which shows the first MAC instructions MIW1A through MIW4A for four threads beginning at clock cycles 1 through 4, respectively. The four threads continue in a round robin manner with the second instruction for the first thread MIW1B beginning at cycle 5. The first instruction for the first thread MIW1A writes the shared memory location during cycle 5. Therefore, by the time the second instruction of the first thread reads the shared memory location at cycle 6, the data is valid. Thus, there is no WBR conflict.

Even if there are not enough threads to achieve full cycle utilization of the MAC, the use of multiple threads may reduce the number of stalls required for one or more threads.

In some embodiments, each thread may be suspended after it completes its processing for a specific tick. Each thread may then be enabled (woken up) at the next regular tick. In one example implementation of the embodiment of FIG. 13, each thread may read from one of the input resources R9, R10 which may be memory mapped. Each thread may then perform a linear convolution, vector multiplication, addition, or any other tasks defined by the instruction generator, then write a result to a register R15 (typically associated with a thread ID). Each thread may then suspend itself until the next tick.

When a thread is suspended, a no-operation (NO-OP) instruction may still be issued to the MAC as the round-robin thread execution continues. A NO-OP instruction may be implemented, for example, as a MAC instruction that writes to a reserved null address. Thus, even if a thread is suspended, the MAC instruction words MIW may be spaced apart for each thread, and therefore, the number of potentially wasted clock cycles spent on avoiding WBR conflicts may be reduced. This implies setting the maximum number of threads in the thread scheduler so that the round-robin cycle length does not change during execution. NO-OP insertion does not avoid WBR problems on its own unless there is a guaranteed minimum number of threads in the round-robin loop. If this is not the case, then a MAC stall mechanism is still needed.

Alternatively, a more complex thread scheduler can skip immediately to the next running thread as it changes the thread context. Then, as the number of running threads decreases towards the end of a tick period, WBR issues are then avoided by relying on the stall mechanism. This approach may be a little more complex, but allows smaller numbers of threads to run, if needed, and allows more rapid execution of the remaining running threads as the number of running threads diminishes. This is because not all instructions have WBR conflicts, so as the number of running threads decreases, the round-robin thread cycle length decreases, and therefore each remaining running thread may be able to run more often.

### Reverse Processing Order of Stages Within a Tick

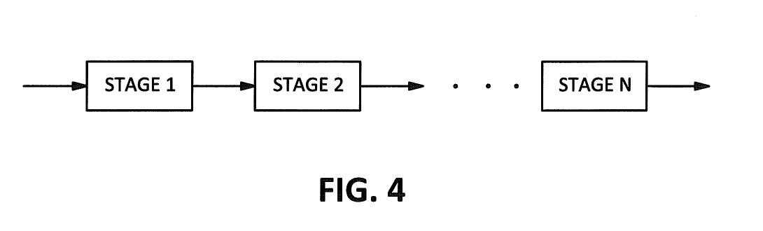

Some additional inventive principles of this patent disclosure relate to the processing order of multi-stage decimation processes. In a decimation process where the decimation factor is large, significant computational savings can be obtained by splitting the decimation process into stages as shown in FIG. 4. The outputs from each stage are used as the inputs to the next stage. When implemented in a DSP or other digital signal processing system, the logical processing order within a tick is to process the first stage to obtain the first stage outputs, then process the second stage using the first stage outputs as the inputs to the second stage, etc.

In an embodiment according to the principles of this patent disclosure, the processing order within a tick may be reversed so that later stages are processed before the earlier stages. An example will be described in the context of a three-stage decimating filter in which each filter stage decimates by two using the following pseudo code where n is the stage number, and filterₙ is the filter routine for that stage:

bₙ=get_dataₙ₋₁( )
aₙ=get_dataₙ₋₁( )
cₙ=filterₙ(aₙ,bₙ)
return(cₙ)

Within a tick, stage 3 is processed first, and the top level of code may appear as follows:

b₃=get_data₂( )
a₃=get_data₂( )
c₃=filter₃(a₃,b₃)
return(c₃)
where a call to get_data₂( ) invokes the following code for the second stage:
b₂=get_data₁( )
a₂=get_data₁( )
c₂=filter₂(a₂,b₂)
return(c₂)
a call to get_data₁( ) invokes the following code for the first stage:
b₁=get_data₀( )
a₁=get_data₀( )
c₁=filter₁(a₁,b₁)
return(c₁)
and a call to get_data₀( ) invokes the following code to get input data:
a₀=input data
return(a₀)

The call to get_data₀( ) may need to suspend the thread for the remainder of the tick. Execution resumes at the beginning of the next tick when new data is available. Thus, an example sequence for three ticks may be as follows, where an arrow (→) indicates a subroutine call:

### Tick 1:

b₃=get_data₂( )→b₂=get_data₁( )→b₁=get_data₀( ), suspend

### Tick 2:

input data at start of tick returned as b₁, a₁=get_data₀( ), suspend

### Tick 3:

input data at start of tick returned as a₁, c₁=filter₁(a₁,b₁), c₁ returned as b₂, a₂=get_data₁( )→b₁=get_data₀( ), suspend

### Changing Order of Filter Subroutine Calls

Some additional inventive principles relate to methods for scheduling tasks within threads to reduce worst-case timing constraints. These principles will be described in the context of hierarchical (multi-stage or cascaded) decimation filtering, but the principles are applicable to other types of processes as well. For example, with hierarchical decimate-by-two filters, the first stage filter process is executed for every other input sample, i.e., once every other tick. The second stage filter process is executed every fourth tick, the third stage is executed every eighth tick, etc. Using a conventional algorithm for decimation filters, there are occasional periodic ticks in which multiple filter processes need to be executed during the same tick, thereby requiring that tick period to accommodate a worst case timing scenario that is excessively long compared to the average time required for each tick.

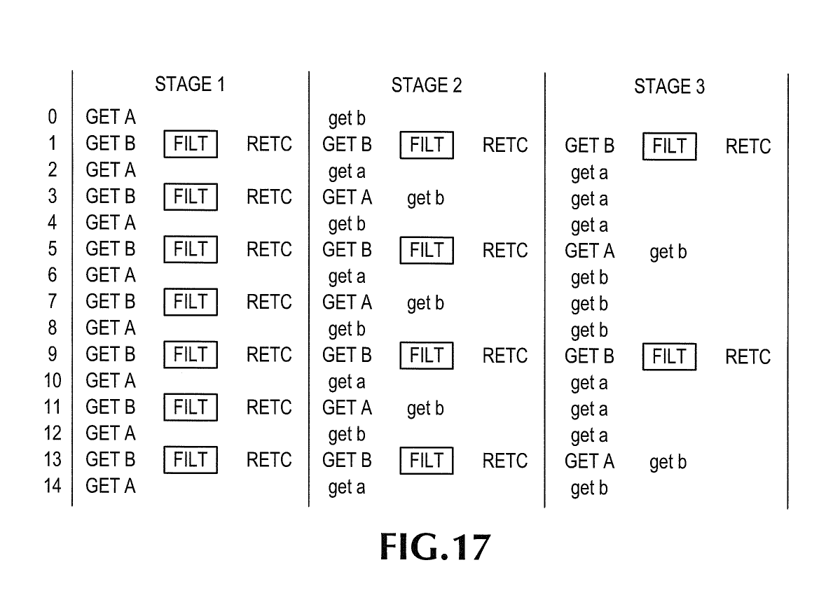

This will be explained with respect to FIG. 17 which illustrates the operation of a three-stage decimation filter in which each stage decimates by two using the following pseudo code where n is the stage number, and filterₙ is the filter routine for that stage:

aₙ=get_dataₙ₋₁( ) // step (1)

bₙ=get_dataₙ₋₁( ) // step (2)

cₙ=filterₙ(aₙ,bₙ) // step (3)

return(cₙ) // step (4)

In step (1), the get_dataₙ₋₁ ( ) routine is called to get input “aₙ”. In step (2), the get_dataₙ₋₁ ( ) routine is called again to get the next input “bₙ”. In step (3), the actual decimation filterₙ(aₙ,bₙ) routine is called to calculate the output “cₙ”, and in step (4), the output value “cₙ” from the decimation filter routine is returned to the next stage or the ultimate output. Each stage uses this same algorithm. Steps (1), (2) and (4) only take a nominal number of clock cycles per tick. Step (3), however, is the actual decimate process which may take a substantially longer time, especially for decimate filters using a large number of filter taps.

In FIG. 17, the function calls for the different stages are shown generically without subscripts to reduce complexity which may be a distraction in the drawing. Each horizontal line shows the portion of the pseudo code that is executed for each stage of the decimation filter for each tick of the timing signal. For each stage n, where n is an integer>0, the first in a contiguous sequence of “geta” (lowercase) symbols indicates that a get_dataₙ₋₁( ) routine was called to obtain input a for stage n, but did not return from the call with a filtered value until the next “GETA” (uppercase) symbol occurs. Likewise, the first in a contiguous sequence of “getb” (lowercase) symbols indicates that the get_dataₙ₋₁( ) routine was called to obtain input b, but did not return from the call with a filtered value until the next “GETB” (uppercase) symbol occurs. “FILT” indicates that an actual filterₙ(aₙ,bₙ) routine for stage n has been called now that it has both its a,b inputs from the lower stage available, and RETC indicates that the value “cₙ” from the decimation filter routine is returned to the next higher stage.

Referring to FIG. 17, the get_data₀( ) call for stage 1 is always successful as indicated by GETA and GETB because they obtain data samples directly from the A/D converter registers or other input resources that provide one input per. Thus, FILT (i.e. filter₁(a₁,b₁)) and RETC for stage 1 are executed every other tick.

For stage 2, the get_data₁( ) routine must wait for RETC from stage one to obtain new data because stage 2 uses the outputs from stage 1 at its inputs. Thus, at tick 2, geta indicates that its call to the stage 1 get_data₁( ) does not return, but at tick 3, GETA obtains a new input from RETC in stage 1. Also during tick 3, get_data₁( ) is called to get input b₁, but it does not return until tick 5. Thus, during tick 5, FILT (i.e. filter₂(a₂,b₂)) and RETC for stage 2 are executed. As is apparent from FIG. 17, FILT and RETC for stage 2 are executed every fourth tick.

For stage 3, the get_data₂( ) routine must wait additional ticks until stage 2 returns data, but eventually the data is obtained and FILT (i.e. filter₃(a₃,b₃)) and RETC for stage 3 are executed every eighth tick.

From FIG. 17 it is apparent that on every eighth tick, i.e., ticks 1, 9, etc., three FILT operations appear in that row, so that the filter₁(a₁,b₁), filter₂(a₂,b₂) and filter₃(a₃,b₃) routines are executed during the same tick. Thus, the duration between ticks must be long enough to accommodate three successive filter processes. This may reduce the usable frequency of the system clock and cause a performance bottleneck.

The following pseudo code illustrates an embodiment of a method according to some inventive principles of this patent disclosure that may reduce or eliminate the execution of multiple filter (a,b) routines during a single tick.

bₙ=get_dataₙ₋₁( ) // step (1′)

cₙ=filterₙ(aₙ,bₙ) // step (2′)

aₙ=get_dataₙ₋₁( ) // step (3′)

return(cₙ) // step (4′)

Here, the steps have been rearranged so that the results of the filterₙ(aₙ,bₙ) call are not returned to the next stage until a different tick. That is, after cₙ=filterₙ(aₙ,bₙ) is completed, calling aₙ=get_dataₙ₋₁( ) will prevent return(cₙ) from being executed because the next “aₙ” data will not be available until a future tick.

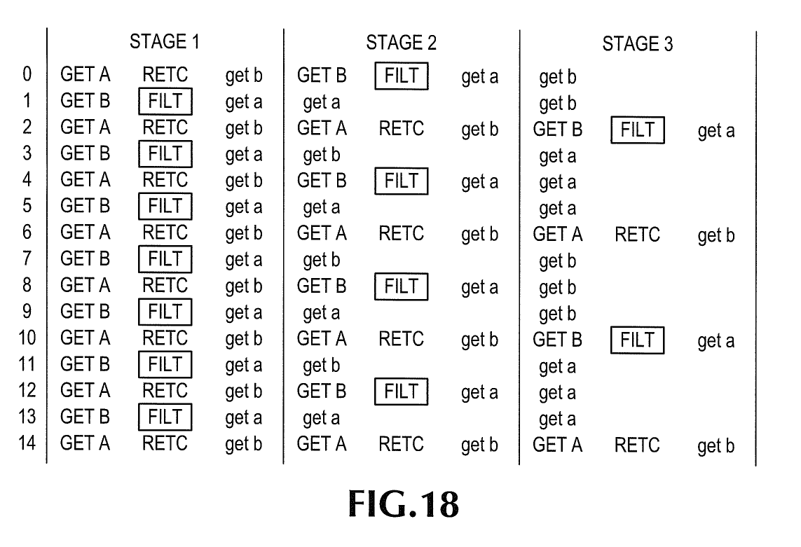

This is illustrated in FIG. 18 which shows the operation of steps (1′) through (4′) in a three stage decimation filter in which each stage decimates by two. By preventing the return of data from one stage to next during the same tick in which a filter routine is executed, the relative alignment of the filter routines is altered so that no more than one filter routine is ever executed during a single tick. Thus, the worst case timing may be substantially reduced. This may enable the usable frequency of the timing signal to be increased and reduce performance bottlenecks.

Other than higher performance, the sequence described in FIG. 18 may produce a different output for a short time at initialization. This is because the very first call to FILT at each stage does not have its ‘a’ input data defined. To make the behavior more deterministic, an implementation may choose to set the ‘a’ values to a known value at power-up, typically clearing them to zero being a convenient choice. Once the second FILT call has occurred at the highest stage number, the results at that point and onwards (while continuing to function correctly), would be essentially the same as for the conventional arrangement of FIG. 17.

The method described in the context of the pseudo-code of steps (1′) through (4′) and FIG. 18 has been illustrated in the context of system utilizing hardware resources as in FIG. 13, but the inventive principles are applicable to any type of digital signal processing system. For example, the pseudo code of steps (1′) through (4′) may be executed on a conventional DSP, general purpose processor, or any other type of processing system.

Moreover, the inventive principles have been described in the context of a decimation filter, but the inventive principles may be applied to any other type of signal processing system, for example, systems having multi-stage processes, in which processes having relatively long execution times may periodically align to create worst case timing situations that are longer than average timing constraints.

### Combination of Reverse Order Processing and Rearranging Filter Routines

The inventive principle relating to scheduling tasks within threads to reduce worst-case timing constraints as described above with respect to FIG. 18 may be combined with the inventive principles relating to the processing order of multi-stage decimation processes to provide yet additional benefits. Thus, in an example three-stage decimating filter in which each filter stage decimates by two, the top level of code may appear as follows:

b₃=get_data₂( )
c₃=filter₃(a₃,b₃)
a₃=get_data₂( )
return(c₃)
where a call to get_data₂( ) invokes the following code for the second stage:
b₂=get_data₁( )
c₂=filter₂(a₂,b₂)
a₂=get_data₁( )
return(c₂)
a call to get_data₁( ) invokes the following code for the first stage:
b₁=get_data₀( )
c₁=filter₁(a₁,b₁)
a₁=get_data₀( )
return(c₁)
and a call to get_data₀( ) invokes the following code to get input data:
a₀=input data
return(a₀)
where get_data₀( ) may need to suspend the thread for the remainder of the tick. Therefore, an example sequence for three ticks may be as follows, where an arrow (→) indicates a subroutine call:

### Tick 1:

b₃=get_data₂( )→b₂=get_data₁( )→b₁=get_data₀( ), suspend

### Tick 2:

input data at start of tick returned as b₁, c₁=filter₁(a₁,b₁), a₁=get_data₀( ), suspend

### Tick 3:

input data at start of tick returned as a₁, c₁ returned as b₂, c₂=filter₂(a₂,b₂), a₂=get_data₁( )→b₁=get_data₀( ) suspend

### Least Common Multiple/Greatest Common Divisor

Some additional inventive principles of this patent disclosure relate to methods for determining worst case timing conditions for multi-thread processes. In the embodiments of FIGS. 13 and 14, the worst case timing may need to be determined to verify that each possible combination of processes for all threads will be completed during a tick. However, each thread may be implemented with a sequence of processes that may span multiple ticks, and each process within a thread may require a different number of instructions. Moreover, each thread may have a different number of processes spread out over a different number of ticks, so the longest processes for each thread may not align except on very rare circumstances. Nonetheless, a worst case timing calculation may be needed to assure that the interval between ticks can accommodate the worst case combination of processes.

One technique to calculate the worst case timing for a group of threads is to compute the total number of instructions for every possible combination of thread processes that may occur between ticks. As the number of threads, the number of processes per thread, and/or number of possible combinations of threads and processes increases, the number of possible combinations may rapidly become unmanageable.

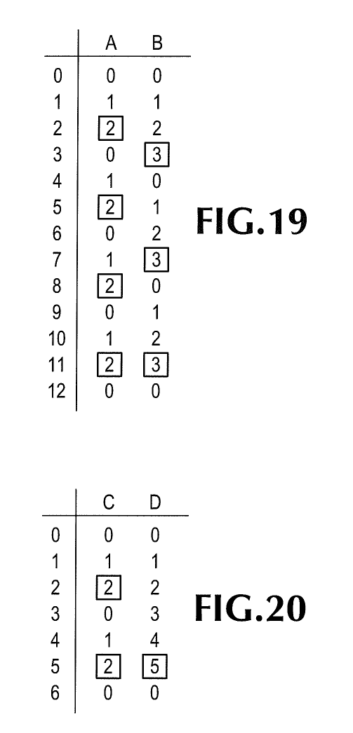

To reduce that total number of combinations that must be analyzed to determine worst case timing, a least common multiple routine maybe utilized according to the inventive principles of this patent disclosure. An example is illustrated in FIG. 19 where thread A has three different possible processes 0-2, of which process 2 is longest as indicated by the box around process 2. Thread B has four different possible processes 0-3, of which process 3 is longest as indicated by the box around process 3. FIG. 19 may be used to visually determine that there are 4×3=12 different possible combinations of threads A and B, and therefore, only these twelve different combinations need to be analyzed for worst case timing. FIG. 20 illustrates another embodiment in which threads C and D have 3 and 6 different possible processes, respectively. Superficially, it would seem that there are 3×6=18 combinations of threads C and D. However, from inspection of the tables, it is apparent that there are only six different possible combinations of threads C and D, before the cycle repeats, and therefore, only these six different combinations need to be analyzed for worst case timing. In fact, the number of combinations that need to be tested is given by the lowest common multiple (LCM) of the cycle lengths of C and D. The LCM is usually calculated as LCM=Product_of Cycle_Lengths/GCD(cycle_lengths), where GCD is the Greatest Common Divisor. The GCD can be calculated efficiently using Euclid's algorithm. The LCM formula above can be easily extended to any number of threads. Typically, the LCM is a much smaller number than the Product_of_Cycle_Lengths, and is never larger. It is only the same (the worst case) when the GCD=1, when none of the cycle length have common factors, i.e. the cycle lengths are all relatively prime to each other.

The LCM method may typically be used to check that all instructions can be executed within a tick period in the worst case, and therefore is of benefit when implemented in the compiler software that generates the code to run on the processor invention. Typically, it would be late in the compiler processing, after instructions are generated, optimized and linked. Knowing the execution times of each instruction, and the maximum number of instructions that can be executed within each tick period, the compiler could issue a warning if it finds that this maximum could be exceeded. The compiler may also attempt to change the sequence of operations, e.g., by changing the relative phases of threads, to improve the timing conditions.

### Function Generation

Some additional inventive principles of this patent disclosure relate to methods and apparatus for preprocessing inputs to an algebra unit to eliminate conditional branches when generating functions.

Signal processing systems often utilize lookup tables to determine the value of a function in response to an argument. To reduce the amount of memory required for a lookup table, the function may be decomposed into sub-functions that require smaller lookup tables. The output values from the smaller lookup tables are then used as operands for various arithmetic operations that calculate the corresponding value of the original function. The tradeoff for reducing the table size is an increased amount of processing time and power consumption for the arithmetic operations. Moreover, the arithmetic operations may require conditional branches that further reduce the speed of the function generation process, and may add complexity to an arithmetic unit that calculates the final values of the function being generated.

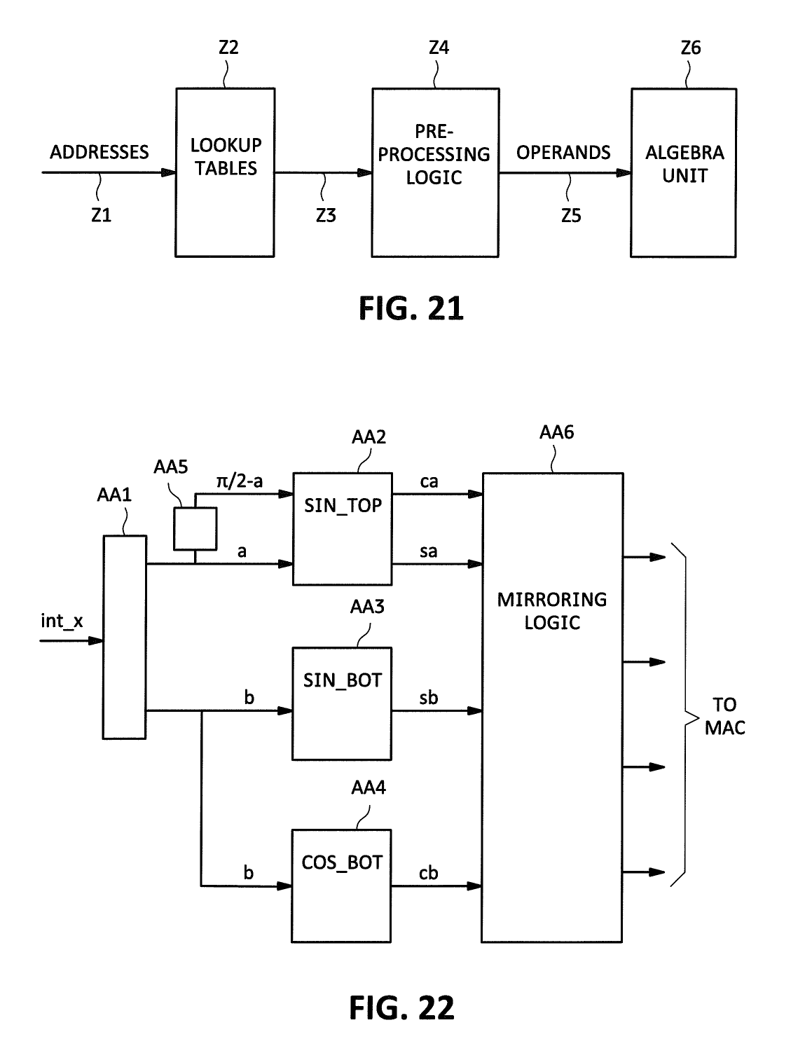

FIG. 21 illustrates an embodiment of a function generator system according to some of the inventive principles of this patent disclosure. The embodiment of FIG. 21 includes one or more lookup tables Z2 that provide output values Z3 in response to input addresses Z1. Rather than using the output values Z3 directly as operands, preprocessing logic Z4 preprocesses the outputs from the lookup tables to generate modified operands Z5 that enable an algebra unit Z6 to process the operands without conditional code execution. The preprocessing function may be implemented with hardware software, or any suitable combination thereof.

Some example embodiments will be described in the context of sine/cosine function generation, but the inventive principles are not limited to these examples. The description below makes use of the C99 language to describe expressions, examples, and code. An exception is for x̂y in equations, which is used to represent x to the power of y.

Signal processing systems (hardware or software) are commonly required to find approximations to the sine and cosine of angles at high speed while using a minimum of memory and computational resources. One well-known method is to use lookup tables, which are fast, but which may need a lot of memory for even modest precisions. Each input to the function is converted to an integer memory address, and the output value is read directly.

To find sin(x) in radians, x can be represented as a 16-bit unsigned integer int_x, such that 0<=int_x<=0xFFFF represents a full sine or cosine cycle (where “<=” is less-than-or-equal to, and 0xFFFF is hexadecimal FFFF or 2̂16−1=65535 in decimal). The values of x and int_x are then related by:

x=int_{—}x*(2*π)/0xFFFF (Eq. 1)

where π is the well-known mathematical constant 3.1415926535 . . . .

The integer representation has the advantage that larger arguments to sine and cosine can be handled by discarding (masking off) bits above the 16-bit unsigned input range. This is because the sine and cosine functions work modulo 2*π, which may be difficult to implement efficiently and accurately for large x, whereas discarding higher bits in int_x is essentially a modulo operation (modulo 2̂16=0x10000 in this example).

To reduce the size of lookup tables, the following well-known trigonometric relations may be used:

sin(a+b)=sin(a)*cos(b)+cos(a)*sin(b) (Eq. 2)

cos(a+b)=cos(a)*cos(b)−sin(a)*sin(b) (Eq. 3)

Now int_x can be split into two parts, a and b, such that

int_{—}x=(a*0x100)+b (Eq. 4)

where 0<=a<0x100 (the top 8 bits of x), and 0<=b<0x100 (the bottom 8 bits of x). Therefore, for all integer values of int_x (even beyond 0xFFFF, if larger integer representations are supported), a and b can be determined from int_x using:

a=(int_{—}x>>8) & 0xFF (Eq. 5)

b=int_x & 0xFF (Eq. 6)

where >> is the C shift-right operator (x>>y is the integer part of x/(2̂y)), and & is the bitwise ‘and’ masking operator. Therefore, for any int_x, a and b may be obtained using Eqs. 5 and 6, and then Eqs. 2 and 3 may be used to obtain sin(int_x) and cos(int_x), requiring only multiplication and addition operations.

From Eqs. 2 and 3, it appears that tables for sin(a), cos(a), sin(b) and cos(b) are required. However, the relation:

cos(x)=sin(π/2−x) (Eq. 7)

can be used to allow cos(a) to be calculated from sin(a), as both tables cover the full domain of each function. This is not true of cos(b) and sin(b), where the small range of b (the bottom 8 bits of 16 in this example) do not overlap. Therefore, just three 8-bit tables may be used to replace two direct 16-bit tables. This requires about 2̂(16−8)=256 times less memory in exchange for some additional simple computations.

The tables are generally initialized prior to operation, and then only the selection and masking (Eqs. 5 and 6) and multiplication, addition, and subtraction operations in (Eqs. 2 and 3) are needed to generate each new sine and cosine value. If both sine and cosine of the same arguments are needed, then computational work can be shared up to and including the lookup tables.

As an added refinement, the mirroring relations shown in Table 1 may be used, where the quadrant numbering is the numeric value of the top two bits of int_x, i.e., with values in the range 0-3. Thus, the first quadrant is quadrant 0, the second quadrant is quadrant 1, the third quadrant is quadrant 2, and the fourth quadrant is quadrant 3.

TABLE 1

| Relation | Mirroring in | Quadrant |
|---|---|---|
| sin(π − x) = sin(x) | input | 1, 3 |
| sin(π + x) = −sin(x) | output | 2, 3 |
| cos(π − x) = cos(x) | input | 1, 3 |
| cos(π + x) = −cos(x) | output | 1, 2 |

Mirroring allows the use of tables with a smaller number of address bits. In this example, if 16 bits in ‘int_x’ represent a complete cycle, then mirroring in the inputs and outputs each reduces the number of address bits by 1, so 14 bits can be used instead of 16 bits. The mirroring on inputs and outputs can be implemented for unsigned 16-bit int_x with the equivalent operations of the following C-code fragment:

```
// sine function mirroring to reduce table sizes
int index = x_int & 0x3FFF; // bottom 14 bits is position within quadrant
int quadrant = (x_int >> 14) & 0x3; // top 2 bits is quadrant
boolean mirror_sine_output = FALSE;
boolean mirror_cosine_output = FALSE;
switch(quadrant)
  {
    case 0: // quadrant 0, 0 <= x <= π/2
      x_addr = index;
      break;
    case 1: // quadrant 1, π/2 <= x <= π
      x_addr = 0x4000 - index; // input mirroring for both sin and cos
        mirror_cosine_output = TRUE;
      break;
    case 2: // quadrant 2, π <= x <= 3*π/2
      x_addr = index;
      mirror_sine_output = TRUE;
      mirror_cosine_output = TRUE;
      break;
    case 3: // quadrant 3, 3*π/2 <= x <= 2*π
      x_addr = 0x4000 - index; // input mirroring for both sin and cos
      mirror_sine_output = TRUE;
      break;
      }
  // code to calculate sine from x_addr is inserted here
if(mirror_sine_output)
  sine = −sine; // invert for second half of sine cycle
if(mirror_cosine_output)
  cosine = −cosine; // invert for second half of sine cycle
```

A problem with this approach is that the mirror_output boolean controls conditional code execution as a final step. This may add complexity in fast hardware dedicated to linear algebra calculations, which primarily consist of pipelined multiplies and adds.

In an embodiment according to some inventive principles of this patent disclosure, a compact lookup table method that takes in an integer angle, processes it with logic, passes the address to lookup tables, and then with some additional logic, passes the result to a multiplication/addition/subtraction linear algebra processing system which then generates sine and cosine outputs directly. Depending on the implementation details, the logic functions may be implemented with relatively simple logic.

The signs of the table outputs of Eqs. 2 and 3 may be changed based on the quadrant, and then the modified table results may be passed to Eqs. 2 and 3 and the results used directly. If Eqs. 2 and 3 are expressed in matrix form:

$$\vert \begin{matrix}sin ( a + b ) \\ cos ( a + b )\end{matrix} \vert = \vert \begin{matrix}sin ( a ) & cos ( a ) \\ cos ( a ) & - sin ( a )\end{matrix} \vert \vert \begin{matrix}cos ( b ) \\ sin ( b )\end{matrix} \vert \qquad ( Eq . 8 )$$

then by inspection, it is apparent that there are only two methods of obtaining each combination of mirroring (negation) on the outputs of the sin( ) and cos( ) tables as shown in Table 2, where the symbol ← is used to denote behavior equivalent to “simultaneously becomes” in all selected assignments.

TABLE 2

| | Method 1 | Method 2 |
|---|---|---|
| Quadrant 0 | No outputs are mirrored in quadrant 0 | |
| Quadrant 1: | sin(a) ← −sin(a) | cos(a) ← −cos(a) |
| (sin(a + b)), −cos(a + b)) | cos(b) ← −cos(b) | sin(b) ← −sin(b) |
| Quadrant 2: | sin(b) ← −sin(b) | sin(a) ← −sin(a) |
| (−sin(a + b)), −cos(a + b)) | cos(b) ← −cos(b) | cos(a) ← −cos(a) |
| Quadrant 3: | sin(a) ← −sin(a) | cos(a) ← −cos(a) |
| (−sin(a + b)), cos(a + b)) | sin(b) ← −sin(b) | cos(b) ← −cos(b) |

Any combination of these two methods can be used for each of three quadrants, giving eight possible combinations. For example, the following code fragment illustrates the use of Method 1 for the mirroring in quadrants 1, 2 and 3:

```
// use Method 1 for each of quadrants 1,2,3
sa = sin(a);
sb = sin(b);
ca = cos(a);
cb = cos(b);
if((quadrant == 1) || (quadrant == 3))
  sa = −sa;
if((quadrant == 2) || (quadrant == 3))
  sb = −sb;
if((quadrant == 1) || (quadrant == 2))
  cb = −cb;
```

Similar solutions can use other combinations of Method 1 and Method 2. For example, the following code fragment illustrates the use of Method 1 for quadrants 1 and 3, and Method 2 for quadrant 2:

```
// use Method 1 for quadrants 1,3, and Method 2 for quadrant 2
sa = sin(a);
sb = sin(b);
ca = cos(a);
cb = cos(b);
if(quadrant != 0)
  sa = −sa;
if(quadrant == 1)
  cb = −cb;
if(quadrant == 2)
  ca = −ca;
if(quadrant == 3)
  sb = −sb;
```

Returning to the example in which Method 1 is used for the mirroring in quadrants 1, 2 and 3, the following code fragment illustrates how the initial values for sa, sb and cb can be obtained from tables sin_table_top[a], sin_table_bot[b] and cos_table_bot[b], respectively, which have 7-bit addressing to access 128 values in each table. Since cos(x)=sin(π/2−x) as set forth in Eq. 7 above, the initial value of ca can be obtained from sin_table_top[0x80−a].

```
// 16-bit unsigned int_x: split off top 2 quadrant bits and lower addr bits
// for position within a quadrant.
int quadrant = (int_x >> 14) & 0x3;
int addr = int_x & 0x3FFF;
int s_addr = addr;
if(quadrant & 0x1) // if in quadrant 1 or 3
  s_addr = 0x4000 - addr;
// extract upper and lower portions of address into 7-bit a,b
int a = (s_addr >> 7) & 0x7F;
int b = s_addr & 0x7F;
// calculate sa=sin(a), ca=cos(a), sb=sin(b), and cb=cos(b)
sa = sin_table_top[a];
ca = sin_table_top[0x80 − a]; // from Eq. 7 above
sb = sin_table_bot[b];
cb = cos_table_bot[b];
// Method 1 for all quadrants
if(quadrant & 0x1) // 1 or 3
  sa = −sa;
if(quadrant & 0x2) // 2 or 3
  sb = −sb;
if((quadrant == 1) || (quadrant == 2))
  cb = −cb;
// linear algebra from here on (no conditional statements after).
// From Equations (2,3) above, with modified input signs based on the
// quadrant.
sin = (sa * cb + ca * sb);
cos = (ca * cb − sa * sb);
```

In an implementation having an algebra unit such as a pipelined multiply-accumulate (MAC) unit, the last two lines of the code fragment above may be executed by the MAC without any conditional code execution (branch instructions). Thus, a fast sine/cosine function generator may be implemented using an existing algebra unit, relatively small lookup tables, and some simple logic to provide preprocessing of the operands for the algebra unit.

FIG. 22 illustrates an example embodiment of sine/cosine logic according to some inventive principles of this patent disclosure. The embodiment of FIG. 22 may be used, for example, to implement the sin/cos logic R4 shown in FIG. 13.

The embodiment of FIG. 22 includes logic AA1 to obtain the first component a as the upper 7-bit portion of the argument int_x and the second component b as the lower portion of the argument. The QUADRANT signal is provided by the numeric value of the top two bits of int_x. The components a and b are applied as addresses to lookup tables AA2 (top sine table), AA3 (bottom sine table), and AA4 (bottom cosine table), which output the operands sa, sb and cb, respectively. Logic AA5 phase shifts the component a by 90 degrees (π/2) so that the top sine table can also be used to generate the operand ca.

Mirror logic AA6 mirrors the operands sa, ca, sb, cb as needed to enable a MAC unit or other arithmetic unit to calculate the value of the sinusoidal function in response to the operands without conditional code execution.

Although shown as separate blocks in FIG. 22, any of the logic functionality illustrated in FIG. 22 may be implemented with hardware, software or any combination thereof.

Appendix E illustrates example code for a sine cosine generation utility which may be integrated into a system such as that shown in FIG. 13.

Appendix F illustrates example code that may be used to test the algorithms described above in C.

### Features and Benefits

The inventive principles described herein may be implemented to provide numerous features and/or benefits depending on the implementation details, combinations of features, etc. Some examples are as follows.

In some embodiments, a configurable controller may be reconfigured depending on the specific processes to be implemented with the control strategy. In some embodiments, the hardware may be configured to perform operations without branch instructions. This may eliminate the branch logic and decision delays associated with branching. For example, hardware may be configured or dynamically reconfigured to perform linear convolution or vector processing without branches.

In some embodiments, limits on MAC output values may be imposed using dedicated hardware, which may reduce processing overhead conventionally associated with software limit checks.

In some embodiments, widely distributed memories may improve MAC performance in terms of data bandwidth efficiency.

In some embodiments, a configurable controller may provide zero overhead task switching.

In some embodiments, the inventive principles may be implemented as a configurable controller having hardware acceleration with high cycle utilization.

In some embodiments, there may be no need to coordinate write-before-read issues because the use of no-operation (NOP) elements may help resolve timing issues.

In some embodiments, threads may be implemented, including running the threads in a round-robin fashion, and yielding to the next thread after each instruction. The number and/or type of threads may set to any suitable values.

In some embodiments, as each thread finishes within a tick period, the round-robin thread cycle is shorted to eliminate that thread, and then any WBR faults are detected, and MAC stalls are inserted as a last resort.

In some embodiments, some of the inventive principles may enable the extension of older semiconductor processing technologies to higher performance levels. For example, a fabrication technology that is nearing the end of its useful life may become competitive again in terms of cost, efficiency, performance, etc., if used to implement a controller according to some of the inventive principles of this patent disclosure.

In some embodiments, and depending on the implementation details, some of the inventive principles may provide or enable the following advantages, features, etc.: (1) configurable real-time control for power conversion applications; (2) high-speed independent control processing and acceleration for a microcontroller; efficient real-time implementation of state-space control system; (3) efficient real-time FIR filters for signal conditioning; (4) efficient real-time multi-rate decimation filtering (enables use of high sample rate converters followed by digital filtering to control the bandwidth of the signal); (5) high-speed sine/cosine generation used to drive high sample rate PWMs (used to generate AC with low-distortion/corrected distortion; (6) simple pipelined MAC may allow for low-gate count/low-power with one multiply-accumulate per clock; (7) multiple memory buses may enable a very high cycle utilization; (8) code/address generator may keep the MAC unit feed with close to 100% cycle efficiency; (9) data may be bounded to a user defined min/max level (each address location); (10) this may enable zero-overhead clipping of data, which may be used primarily to limit the values of integrators, but can be used on any state variable; (11) inputs and output may be registered on a clock boundary, e.g., enabling a fixed one ADC clock delay through the system, e.g., output can be skewed relative to this clock; (13) an internal state can be logged without altering the timing; (14) hardware fault detection, e.g., stack/PC overflow/underflows may be detected and outputs may be disabled, thus, completion of code execution in allocated time may be checked and outputs disabled if error is detected.

Some additional following advantages, features, etc., may be realized in some embodiments, and depending on the implementation details: (15) zero overhead task switching (fine grain, instruction level task switching) which may enable hiding the pipeline with other tasks; (16) separate data/coefficient/limit/address RAMs; (17) deterministic run-time behavior; synchronous inputs and output to the host controller (may be deterministic because the number of clock cycles are known in advance); (18) hardware fault detection; redundancy and safety margin improvement.

### APPENDICES

Appendixes A through E illustrate examples of code, processes and/or methods that can be implemented using the systems of FIGS. 13 and 14, as well as other embodiments of signal processing systems according to the inventive principles of this patent disclosure.

Appendices A and B illustrate example embodiments of an intermediate instruction word IIW and a MAC external instruction word MIW, respectively, in the format of Verilog code. The symbol “//” marks the start of a comment line which applies to Verilog declaration below the comment. A signal name such as “signal_name[x-1:0]” defines a bus “signal_name” of width×wires, with wire indices 0 through x−1 where 0 is the least significant bit. Bus widths are not defined in the example IIW, but can be chosen based on the level of performance needed. The choice of bus widths affects the number of gates used to implement the instruction words.

Appendix C illustrates an example of code for a signal processing engine using hardware that on each clock can perform a Multiply-Accumulate (MAC) instruction.

Appendix D illustrates example code to run on a compiler using system language as described in Appendix C. The subroutine filt1 illustrates an example of the method for reducing worst case timing constraints as described above in the context of FIG. 18.

Appendix E illustrates example code for a sine cosine generation utility which may be useful, for example, in phase lock applications such as locking the output of a AC power source to a grid waveform.

Appendix F illustrates example code that may be used to test the sine/cosine generation algorithms described above.

The inventive principles of this patent disclosure have been described above with reference to some specific example embodiments, but these embodiments can be modified in arrangement and detail without departing from the inventive concepts. For example, some of the embodiments have been described in the context of synchronous logic, but the inventive principles may be applied to embodiments that employ asynchronous logic as well. Such changes and modifications are considered to fall within the scope of the following claims.

1. A method for processing a main function in response to an argument having first and second components, the method comprising:
obtaining a first operand as a first sinusoidal function (sine) of the first component from a first lookup table;
obtaining a second operand as a first sinusoidal function of the second component from a second lookup table;
obtaining a third operand as a second sinusoidal function of the first component from the first lookup table;
obtaining a fourth operand as a second sinusoidal function of the second component (b) from a third lookup table;
performing a mirroring operation on the operands; and
calculating the value of the main function using a pipelined multiply-accumulate (MAC) unit in response to the first, second, third and fourth operands, after performing the mirroring operation.

2. The method of claim 1 where the mirroring operation comprises:
determining a quadrant of the argument; and
conditionally mirroring the operands in response to the quadrant.

3. The method of claim 2 where calculating the value of the main function comprises adding the product of the first operand and the fourth operand to the product of the second operand and the third operand using the MAC unit.

4. The method of claim 2 where calculating the value of the main function comprises subtracting the product of the first operand and the second operand from the product of the third operand and the fourth operand using the MAC unit.

5. The method of claim 2 where:
the first sinusoidal function comprises a sine function; and
the second sinusoidal function comprises a cosine function.

6. The method of claim 5 where:
the first component comprises an upper portion of the argument; and
the second component comprises a lower portion of the argument.

7. The method of claim 6 where:
the first table comprises a sine table for the upper portion of the argument;
the second table comprises a sine table for the lower portion of the argument; and
the third table comprises a cosine table for the lower portion of the argument.

8. The method of claim 7 where conditionally mirroring the operands in response to the quadrant consists essentially of:
inverting the first operand if the argument is in the second or fourth quadrants;
inverting the second operand if the argument is in the third or fourth quadrants; and
inverting the fourth operand if the argument is in the second or third quadrants.

9. A method for processing a function in a digital signal processing system having a linear algebra unit, where the function has an argument with two or more components, the method comprising:
obtaining operands in response to the components of the argument using the lookup tables;
preprocessing the operands to enable the linear algebra unit to process the operands without conditional code execution; and
calculating the value of the function in response to the operands using the linear algebra unit.

10. The method of claim 9 where:
the size of at least one of the lookup tables can be reduced through mirroring; and
preprocessing the operands comprises conditionally mirroring the operands.

11. The method of claim 10 where mirroring the operands comprises mirroring the operands on the outputs of the lookup tables.

12. The method of claim 10 where mirroring the operands comprises mirroring the operands in response to a quadrant of the argument.

13. The method of claim 9 where the function comprises a sinusoidal function, and the operands comprise sinusoidal functions of the components of the argument.

14. The method of claim 13 where:
the components of the argument are represented as a and b; and
the function can be calculated as:
sin(a)*cos(b)+cos(a)*sin(b); or
cos(a)*cos(b)−sin(a)*sin(b).

15. A digital signal processing system comprising:
a pipelined linear algebra unit; and
a logic unit coupled to the pipelined linear algebra unit;
where the logic unit comprises logic to:
obtain operands for calculating a sinusoidal function from lookup tables;
preprocess the operands to enable the linear algebra unit to calculate the value of the sinusoidal function in response to the operands without conditional code execution; and
pass the operands to the pipelined linear algebra unit.

16. The system of claim 15 where the pipelined linear algebra unit comprises a multiply-accumulate unit.

17. The system of claim 15 where:
the sinusoidal function has an argument with first and second components; and
the logic unit comprises logic to obtain first, second, third and fourth operands from the lookup tables in response to the first and second components.

18. The system of claim 17 where the logic unit comprises mirror logic to conditionally invert outputs from the lookup tables in response to the quadrant of the argument.

19. The system of claim 18 where:
the first component comprises an upper portion of the argument;
the second component comprises a lower portion of the argument.

20. The system of claim 19 where the lookup tables comprise:
a sine table for the upper portion of the argument;
a sine table for the lower portion of the argument; and
cosine table for the lower portion of the argument.

21. A method for generating a periodic function in response to an argument in a digital signal processing system, where the periodic function can be represented as functions of two or more components of the argument, the method comprising:
obtaining a first operand from one of two or more lookup tables in response to a first component of the argument;
obtaining a second operand from one of the lookup tables in response to a second component of the argument;
conditionally mirroring the first and second operands in response to a quadrant of the argument; and
calculating a value of the periodic function in response to the operands with a linear algebra unit without using conditional code execution.

22. The method of claim 21 further comprising:
obtaining a third operand from one of the lookup tables in response to the first component of the argument;
obtaining a fourth operand from one of the lookup tables in response to the second component of the argument;
conditionally mirroring the third and fourth operands in response to the quadrant of the argument.

23. The method of claim 22 where:
the first component comprises an upper portion of the argument; and
the second component comprises a lower portion of the argument.

24. The method of claim 23 where the periodic function comprises a sinusoidal function, and the operands comprise sinusoidal functions of the components of the argument.

25. The method of claim 21 where the linear algebra unit comprises a pipelined multiply-accumulate unit.
